(19) United States
(12) Patent Application Publication
(10) Pub. No.: US 2022/0184984 A1
(43) Pub. Date: Jun. 16, 2022

(54) APPARATUS FOR MARKING ELECTRIC DEVICES WHICH CAN BE LINED UP NEXT TO ONE ANOTHER

(71) Applicant: Weidmüller Interface GmbH & Co. KG, Detmold (DE)

(72) Inventors: Christian DÜLME, Paderborn (DE); Stefan LORENZ, Schlangen (DE); Michael GOCKEL, Bad Driburg (DE); Jan MARRENBACH, Warstein (DE); Davor DEPRATO, Kappel (CH); Ronny MENZEL, Dresden (DE); Clemens SCHNEIDER, Chemnitz (DE)

(21) Appl. No.: 17/593,725

(22) PCT Filed: Mar. 5, 2020
(86) PCT No.: PCT/EP2020/055917

§ 371 Date: Sep. 23, 2021

(30) Foreign Application Priority Data
Mar. 29, 2019 (DE) 102019108297.8

(51) Int. Cl. B41M 5/24; B41J 3/407

(52) U.S. Cl. CPC B41M 5/24; B41J 3/4073

(57) ABSTRACT

An apparatus for marking electric devices which can be arranged next to one another and mounted on a support rail includes a receptacle for the support rail and a laser head for applying a marking to the electric devices. The receptacle is mounted for pivotal movement about its longitudinal axis and the laser head is guided for movement in at least one longitudinal direction parallel to the longitudinal axis of the receptacle.

This application is a § 371 National Stage Entry of International Patent Application No. PCT/EP2020/055917 filed Mar. 5, 2020. Application No. PCT/EP2020/055917 claims priority of DE 10 2019 108 297.8 filed Mar. 29, 2019. The entire contents of these applications are incorporated herein by reference.

### BACKGROUND OF THE INVENTION

The invention relates to an apparatus for marking electric devices which can be lined up next to one another and arranged on a support rail. The apparatus comprises a receptacle for the support rail and a laser head for applying a marking to the electric devices.

Support rails are used for snapping or clipping electric devices onto a support rail when constructing an electrical assembly. In particular, prefabricated support rail sections are commonly used which are then incorporated on site in switch cabinets containing a plurality of electric devices lined up next to one another. The electric devices are typically terminal blocks, each of which in turn includes a plurality of connections. In order to facilitate wiring of the electrical assembly within the switch cabinet, the individual devices and their connections including marking surfaces for marking or labelling.

### BRIEF DESCRIPTION OF THE PRIOR ART

International publication No. WO 2010/057768 A1 discloses an apparatus by which support rails can be equipped in an automated manner with electric devices, in particular terminal blocks. A printing unit is provided which prints on the marking surfaces of an electric device removed from a magazine, before the electric device is mounted on the support rail.

International publication No. WO 2017/125364 A1 discloses an alternative approach wherein the support rails are first equipped with the electric devices and then the devices are marked. For this purpose, a marking apparatus includes a support rail receptacle as well as a laser head which applies the desired markings on the marking fields or surfaces of the devices. The receptacle apparatus for the support rail is coupled to a linear displacement and pivoting apparatus so that the support rail with the electric devices in front of the laser head can be displaced and pivoted in order to be able to move the labeled marking fields into the labeling region of the laser head.

In large switch cabinets or switch devices, support rails are used which have a length in the range of one meter to more than one meter. In order to be able to displace a support rail section of this length by the apparatus in front of a laser head so that the laser head can reach the entire length of the support rail, a displacement device having a length at least twice the length of the support rail is necessary. In order to be able to process long support rails, the apparatus therefore has a corresponding space requirement. With increasing length of the apparatus, the demand for stability and quality of the guides of the shifting and pivoting apparatus increases in order to achieve a corresponding position accuracy over the entire displacement range of the shifting and pivoting apparatus and insensitivity with respect to external or internal vibrations that are generated.

### SUMMARY OF THE INVENTION

An object of the present invention is to create a marking apparatus of the type mentioned above which has a relatively small space requirement measured on the length of the processable support rails and which achieves a high position accuracy and insensitivity to vibration with relatively low material expense.

An apparatus according to the invention for marking electric devices of the type mentioned above which can be lined up next to one another is characterized in that the receptacle for the support rail of the marking apparatus is pivotably mounted about its longitudinal axis and in that a laser head is guided in at least one longitudinal direction running parallel to the longitudinal axis of the receptacle.

In comparison to the apparatus known from the prior art, the necessary relative movements between the laser head and the devices to be marked are divided in such a manner that linear guiding is carried out by the laser head, whereas the electric devices are only pivoted and not displaced. Therefore, the receptacle for the support rails does not have to be capable of performing a displacement movement over the entire length of the support rail so that the receptacle can be designed to be shorter than those of the prior art. A linear guide for the laser head which performs this shifting movement is arranged parallel to and next to the receptacle so that the entire construction length is not increased.

In addition, the stationary arrangement of the pivotable receptacle as well as the shorter construction enable a solid design of the receptacle with less material expense so that pivoting movement can be performed with high rotation acceleration but low vibrations. The linear guide for the laser head also requires little material expense since it does not have to be designed to accommodate high torques and transverse forces which occur during the rotational acceleration of the pivoting movement.

In the context of the present application, the term “electric device” denotes any device with a support rail receptacle for assembly on a support rail. This device includes purely passive terminal blocks and devices with switch or fuse elements such as, for example, automatic circuit breakers and devices with electronic components or components which can be attached to or mounted on a support rail.

In an advantageous embodiment of the invention, the receptacle includes a longitudinal support with a receiving bed for receiving the support rail which is held off-center with respect to a rotation axis by pivot arms. Preferably, the receiving bed is arranged approximately 20 to 30 millimeters (mm) off-center from the center of the rotation axis.

The off-center pivoting movement of the receptacle and thus of the support rail is based on the finding that, on average, the center of gravity of the electric devices to be labeled, particularly in the case of terminal blocks, lies approximately 20 to 30 mm above the support rail receptacle of the electric devices. As a result of the receiving bed being spaced from the rotation axis, the electric devices are rotated on average about their own center of gravity, which allows a rapid and as inertia-free as possible rotation. Thus, the forces occurring during acceleration of the rotation are minimized. In this way, the highest possible rotational acceleration and thus the fastest possible pivoting movement are achieved which shortens the marking process overall.

In an additional embodiment, a shiftable slider is arranged on the longitudinal support in order to be able to secure support rails of different length. Preferably, both on the longitudinal support and on the slider, receiving lugs are provided in order to be able to overlap the support rail on its ends and thus clamp it in place. With the shiftable slider, devices on support rails of different lengths can be marked.

In a further embodiment, on or in the longitudinal support, in the region of the receiving bed, electromagnets are arranged in order to secure the support rails on the receiving bed. Preferably, a rotary feed-through is arranged on the receptacle in order to couple a current supply for the electromagnet.

Alternatively, it is also possible to use permanent magnets or a combination of electromagnets and permanent magnets, in order to hold the support rail in the receiving bed.

According to a further embodiment of the invention, lateral guide plates protrude laterally above the plane of the receiving bed in the longitudinal direction of the support rails. The lateral guide plates are helpful for longer support rails since longer support rails tend to sag during production and/or transport. Due to this sagging, exact positioning of the support rails and of the electric devices to be labeled would not exist without the lateral guide plates. Preferably, the lateral guide plates protrude approximately 2 to 6 mm over the plane of the receiving bed in order to surround the support rail laterally in a lower region. In this region, they do not collide with the mounted electric devices. The lateral guide plates are preferably designed as spring steel plates so that they can compensate for tolerances in the width of the support rail. Support rails are usually rounded between their base and the vertical sides, since they are typically made as stamped and bent parts. Due to the radius and during pressing of the support rails onto the receiving bed, centering between the lateral guide plates occurs. With securing of the support rails, support rails of different heights can be used.

Moreover, it is advantageous to mount the receptacle so that it can be pivoted by a rotation angle of more than 360°. Preferably, the rotation angle is also clearly greater than 360° and, for example, 720°. It can also be provided that any rotation angles are possible. The rotary feed-through is designed so that a current supply for the electromagnets can occur over the entire rotation range. The free pivotability achieved in this manner makes it possible to pivot the support rail in any direction and thus to switch to additional labeling positions in any situation on the shortest rotation path. Accordingly, it is possible to switch to a subsequent labeling position with a rotation of less than 180°.

According to a further embodiment of the invention, a linear guide with a shiftable carriage, on which the laser head is mounted directly or indirectly, is arranged parallel to the receptacle. The laser head can be mounted on the carriage via one or more additional linear guides which run perpendicular to the linear guide. An additional linear guide in the horizontal direction makes it possible to bring the laser head to an appropriate focal distance from the surface to be marked if the laser head does not internally have possibilities for varying the focal distance. An additional further linear guide in the vertical direction widens the marking region upward and downward.

In another embodiment, the laser head includes a laser which emits in an ultraviolet (UV) wavelength range. Light in the UV wavelength range offers the advantage that markings can be applied on almost any plastic surface. The electric devices to be marked can include designated fields for marking, but they do not have to be provided with a special coating or special plastic as is generally necessary for markings with infrared (IR) light. In addition, it is possible to apply markings to regions of the electric devices which are not specifically designated. The applied markings can include pure color variations and, when appropriate parameters and focusing of the laser radiation are used, material removal or material modification, which makes the markings sensitive to touch to form tactile markings.

### BRIEF DESCRIPTION OF THE FIGURES

The invention will be described in further detail below with reference to the accompanying drawing, in which:

FIGS. 1 and 2 are front perspective views of an apparatus for marking electrical devices with different configurations of terminal blocks mounted thereon, respectively;

FIG. 3 is a rear perspective view of the marking apparatus;

FIG. 4 is a front perspective view of a marking apparatus with shorter support rail;

FIGS. 5a-5c are front perspective, front and top views, respectively, of a marking apparatus showing a longitudinal support without any electrical components mounted thereon; and

FIG. 6 is a sectional view of the longitudinal support shown in FIGS. 5a-5c.

### DETAILED DESCRIPTION

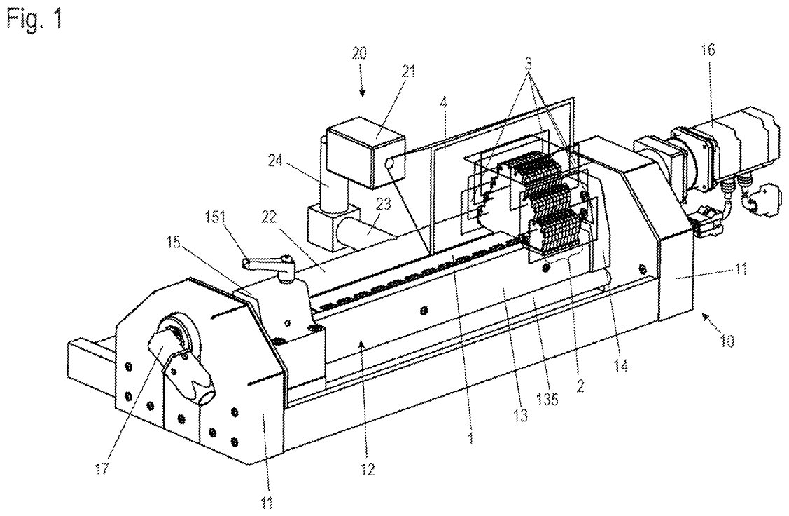

In FIGS. 1-4, an embodiment of an apparatus for marking electric devices which can be arranged next to one another is shown in respective isometric representations. The marking apparatus includes a support rail 1 on which a number of electric devices 2 are mounted in a snap or click on manner. All of the devices 2 shown in the figures of this application are terminal blocks. However, it is understood that other electric devices or electronic devices, such as, for example, fuses or circuit breakers, can also be arranged next to one another on the support rail 1 and can be marked by the apparatus shown. It is only for simplification of the representation that the electric devices 2 are also referred to as terminal blocks 2 below.

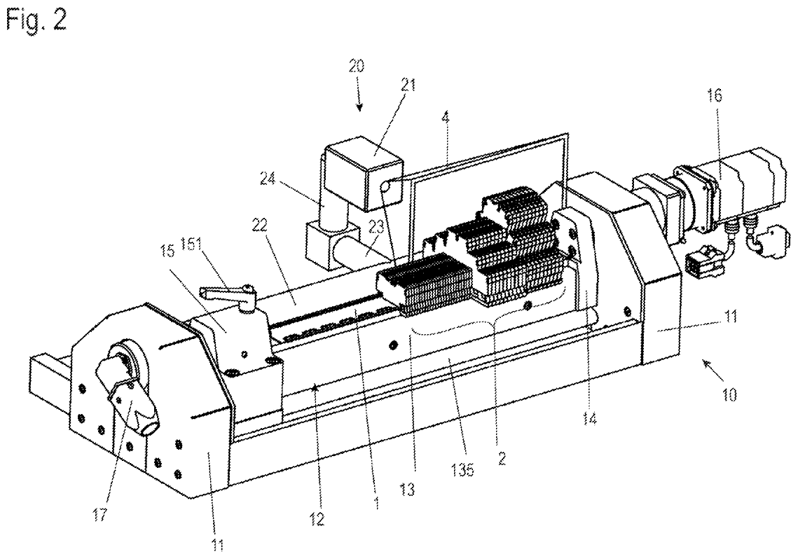

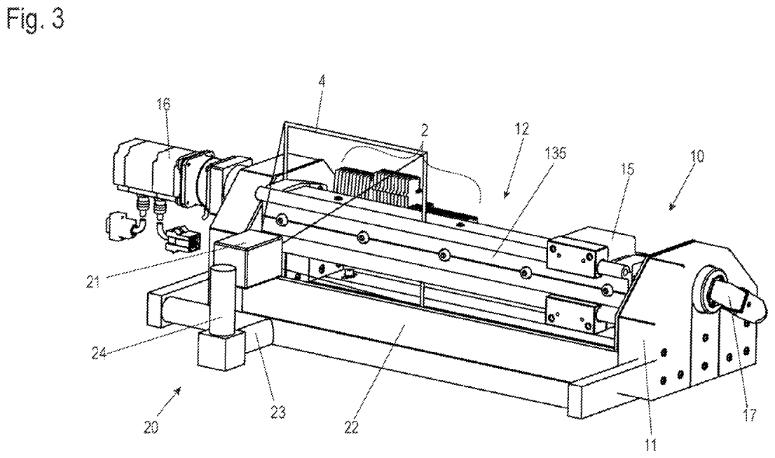

FIGS. 1, 2 and 4 show the marking apparatus with differently equipped support rails 1. The viewing direction in which the device is represented is the same in the three figures. FIG. 3 shows the marking apparatus with the support rail 1 and the terminal blocks 2 according to FIG. 2 from another viewing direction.

For receiving and for pivoting movement of the support rail 1 with the terminal blocks 2, the marking apparatus includes a pivoting apparatus 10. The marking or labeling on the terminal blocks 2 is performed by a laser assembly 20.

The pivoting apparatus 10 includes a frame 11 in which a receptacle 12 designed in the manner of a swing is arranged for rotation about its longitudinal axis. The receptacle 12 includes a longitudinal support 13 which extends in a longitudinal direction and which is supported on both ends by pivot arms 14 off-center with respect to a rotation axis. This rotation axis is pivotably mounted in corresponding bearings in end portions of the frame 11 and coupled to a drive 16. The drive 16 is, for example, an actuating drive with a position encoder. In order to achieve high torques and correspondingly rapid rotational acceleration and short positioning times, a direct current motor, preferably with rotational speed reduction, is suitable for the actuating drive.

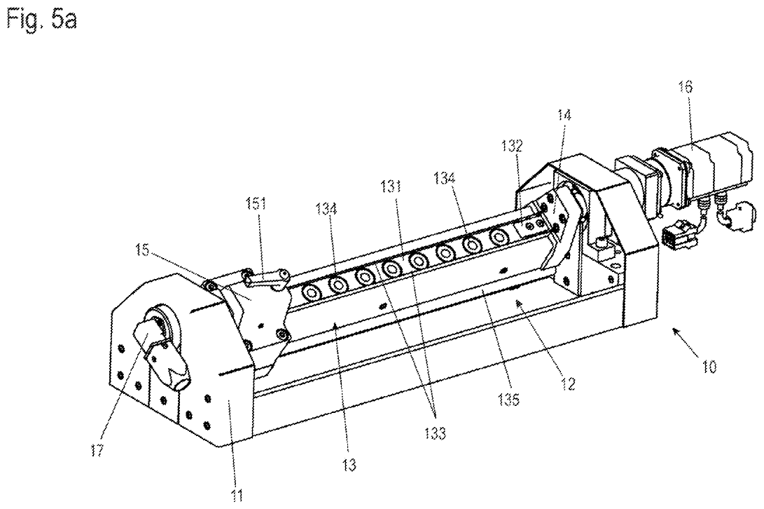

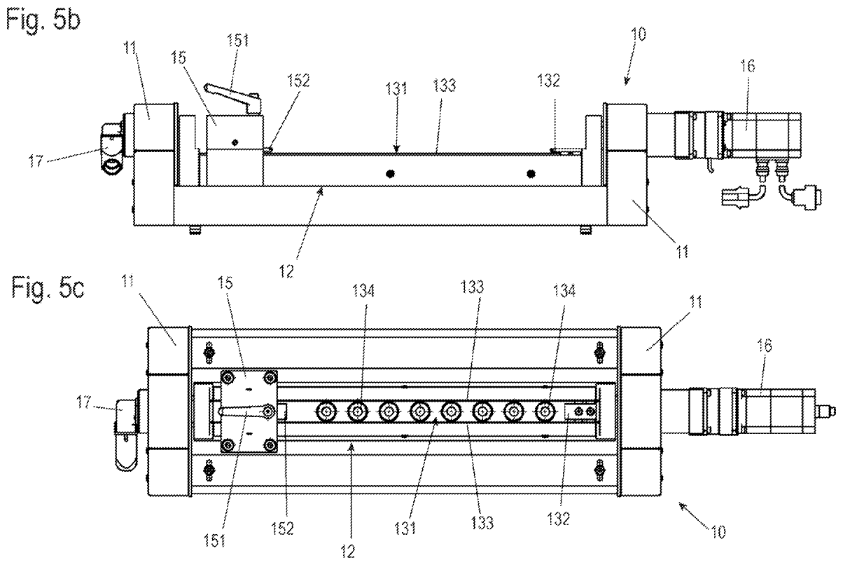

For marking, the support rail with the terminal blocks 2 thereon is attached to the longitudinal support 13 which includes a receiving bed 131. The receiving bed 131 and additional details of the longitudinal support 13 can be seen in FIGS. 5a-5c which represent the pivoting apparatus 10 in different views separately from the laser assembly 20 and without the support rail 1. FIG. 5a shows the pivoting apparatus 10 in an isometric view, FIG. 5b shows it in a side view, and FIG. 5c shows it in a top view.

At one end of the longitudinal support 13, a fixed receiving lug 132 is arranged under which an end section of the support rail 1 is shifted in order to secure the support rail on this side on the receiving bed 131. The opposite end of the support rail 1 is secured by a similar receiving lug 132 which is not stationary but arranged on a shiftable slider 15. The slider 15 is guided longitudinally on the longitudinal support 13 for movement or shifting on the support. Guide rails 135 are provided laterally on the longitudinal support 13 to guide the slider. The slider 15 is equipped with a quick-release lever 151 which locks or releases the slider 15 for movement on the longitudinal support 13. After loosening the slider 15, it can be shifted in the direction of the attached support rail 1 until a receiving lug 152 fastened on the slider 15 as shown in FIGS. 5b and 5c secures the support rail 1 in the receiving bed 131.

In addition, lateral guide plates 133 are provided in a longitudinal direction of the longitudinal support 13 on the lateral margins of the receiving bed 131 to laterally guide the support rail 1 along its entire length.

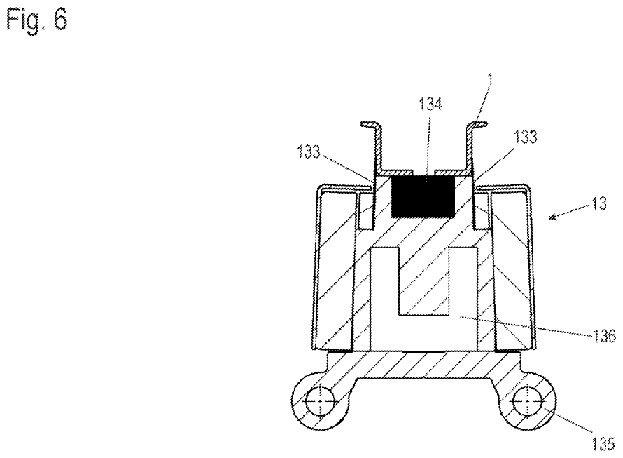

In FIG. 6, a cross section through the longitudinal support 13 with an attached support rail 1 is shown. The lateral guide plates 133 surround the support rail 1 laterally in a lower region. The lateral guide plates 133 are preferably formed as spring steel plates so that they can compensate for tolerances in the width of the support rail 1. The lateral guide plates 133 are preferably designed to be sufficiently thin and to protrude only sufficiently far above the receiving bed 131 that they in fact guide and position the support rail 1 but do not collide with mounted electric devices 2. This is possible since the support rail receptacles on the electric devices 2 usually includes a small lateral free space at least in the lower region of the support rail. The lateral guide plates 133 are particularly helpful for longer support rails 1 since longer support rails 1 tend to sag. Due to this sagging, an exact positioning of the support rails and thus of the labeled electric devices would not be available or achieved by the lateral guide plates 133.

Moreover, in the receiving bed 131 a plurality of electromagnets 134 are arranged in the receiving bed and longitudinally spaced apart from one another. After the support rail 1 has been attached, the electromagnets 134 energized individually, in groups or jointly so that they secure the support rail 134 firmly and without a gap due to sagging in the receiving bed 131. A current supply for the electromagnets 134 occurs via a rotary feed-through 17, which is preferably arranged on the side of the pivoting apparatus 10 opposite the drive 16.

Due to the shiftability of the slider 15, support rails 1 of different length are available for the pivoting apparatus. Depending on the manner of securing the support rail, support rails of different height can be inserted.

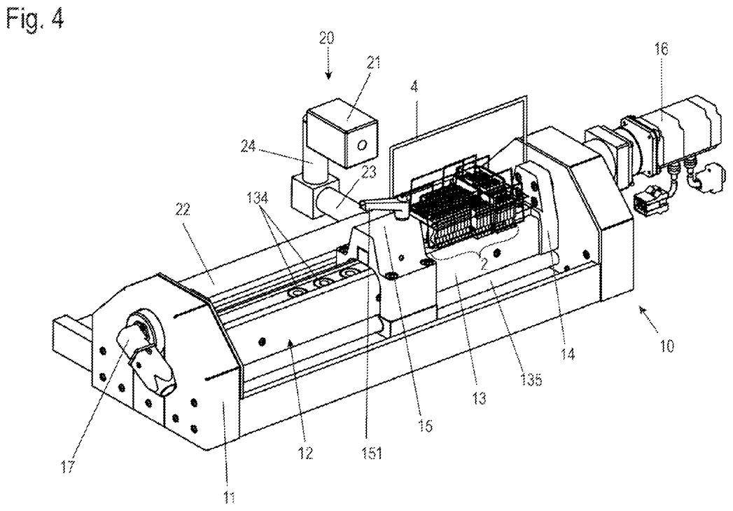

FIG. 4 shows an example of a marking device with a shorter inserted support rail 1. It is also possible to energize all the electromagnets 134. Alternatively, only a number of electromagnets 134 which are located in the region of the actually inserted support rail 1 are energized to secure the rail.

As shown in FIG. 6, a channel running in the longitudinal direction of the longitudinal support 13 is formed in the longitudinal support 13 through which cables for energizing the electromagnets 134 can run. The channel 136 also affords weight reduction in order to minimize the rotational moment of inertia of the receptacle 12 in order to achieve a high rotational acceleration with the lowest possible torque.

Due to the pivot arms 14, the receiving bed 131 for the support rail 1 is arranged off-center from the rotation axis during rotation. Preferably, the spacing of the receiving bed 131 from the rotation axis is in the range from 20 to 30 millimeters (mm) and in particular it is approximately 23 mm. On average, the center of gravity of the electric devices 2—in particular terminal blocks—to be labeled is approximately 23 mm above the support rail receptacle of the electric devices 2. If the receiving bed 131 is spaced from the rotation axis, the electric devices 2 are rotated on average about their own center of gravity, which enables a rapid rotation which is as inertia-free as possible. The forces occurring during acceleration of the rotation are thus minimized. In this way, the highest possible rotational acceleration and thus the fastest possible pivoting movement are achieved which shortens the marking process overall.

Preferably, the drive 16 and the rotary feed-through 17 are designed so that an unlimited rotation angle during rotation of the receptacle 12 is possible. In this way, the rotation or pivoting movement of the receptacle 12 can always occur in any direction regardless of otherwise existing limitations. The advantage arising for the marking process will be further explained in greater detail below.

As mentioned above, the laser assembly 20 is arranged laterally next to the pivoting apparatus 10 in the region of the receptacle 12. The marking on the electric devices 2, that is to say on the terminal blocks 2 in the represented example, occurs by means of a laser head 21 which includes all of the necessary components for the application of labeling, in particular a laser as well as deflection and focusing units in order to be able to deflect the laser beam for application of the marking.

For marking of the electric devices 2 with a laser, different techniques can be used. For example, it is possible to use an infrared laser, for example a CO2 laser, which emits light having a wavelength of approximately 10.6 micrometers (μm). When an infrared laser is used, it is conventional to provide on the electric devices 2 infrared radiation-sensitive marking surfaces which change color when struck by infrared laser radiation, so that a marking can be applied. The marking surfaces can be present on the electric devices in the form of stickers, applied coatings and/or by providing marking sections, and/or by use of a corresponding infrared-sensitive plastic in sections.

Moreover, it is possible to use a laser head 21 with a laser which emits in the ultraviolet wavelength range from approximately 190 to 380 nanometers (nm), in particular a laser emitting at 355 nm. Such a laser can be, for example, an Nd:YAG laser or a CO2 laser with downstream frequency tripling. Light in the UV wavelength range offers the advantage that markings can be applied on almost any plastic surface. The electric devices can include designated fields for marking, but they do not have to be provided with a special coating or a special plastic. In addition, it is possible to apply markings on regions of the electric devices that are not especially designated. Moreover, by suitable parameters and focusing of the laser radiation, not only pure color variations can be used for marking, but material removal or material modification of the marked material can also be achieved to provide raised or recessed tactile marking.

The laser head 21 is actuated by a control apparatus, not shown, in order to apply a label within a focal area 4. The focal area 4 is represented in FIGS. 1-4. The exact size as well as the spacing in which the focal area 4 is located in front of the laser head 21 depends on the projection properties of the laser head 21. Within the focal area 4, the laser head 21 can apply markings, in particular characters, numbers and/or symbols, on surfaces to be marked. In general, a laser beam generated in the laser head 21 is deflected via multiple rotatable or pivotable mirrors in order to reach each point in the focal area 4. Since the mirrors have a low inertia, the movement of the mirrors and thus the deflection of the laser beam is a rapid process in comparison with other mechanical movements in the system.

As can be seen in FIGS. 1-4, the focal area 4 is smaller than the maximum length of the support rail 1 with the electric devices 2 to be labeled arranged thereon. In order to allow labeling along the entire length of the support rail 1, the laser arrangement 20 has a linear guide 22 in longitudinal direction of the longitudinal support 13. This direction is referred to below as the z-direction. The linear guide 22 extends over substantially the entire length of the receptacle 12 of the pivoting apparatus 10. The linear guide 22 can be formed, for example, as a spindle drive or rack drive. However, other drives are also possible. For clarity, the drive motors of the linear guide 22 are not represented explicitly in the figures.

On a movable carriage of the linear guide 22, the laser head 21 is fastened via a holder which allows a position setting of the laser head 21 in the x- and y-directions perpendicular to the z-direction. In the embodiment shown in the drawing, a linear guide 23 in the x-direction and a linear guide 24 in the y-direction are provided. In the illustrated embodiment, the x-direction runs horizontally and the y-direction runs vertically.

Due to shifting of the laser head 21 in the x-direction via the linear guide 23, the spacing of the laser head 21 from the region to be labeled can be varied. Due to shifting in the y-direction with the help of the linear guide 24, regions to be marked located farther above or below can be reached. If the laser head 21 has an internal possibility of adjusting the focal distance, then the linear guide 23 can be dispensed with and designed as a holder with a fixed spacing. If the variety of models of the electric devices 2 to be labeled does not involve great differences in the height of the devices, then under some circumstances, a linear guide in the y-direction can be dispensed with and the corresponding linear guide 24 can be designed as a fixed holder. The difference in height relates to a variation of the spacing of the regions to be marked from the support rail.

The marking process is explained in further detail below.

For the application of marking to the electric devices 2 of the support rail 1, the laser head 21 is moved with the help of the linear guide 22 so that at least some of the markings to be applied are located in the region of the focal area 4. In the example of FIG. 1, marking planes 3 are drawn which indicate planes in which the markings are to be applied onto the different terminal blocks 2. In the example of FIG. 1, a plurality of identical terminal blocks 2 are arranged on the support rail 1, wherein the regions to be marked on different sides of the terminal blocks 2 are arranged on contacts arranged at different heights (with respect to the support rail 1). In a marking plane 3, all of the markings are received which can be applied onto one or more of the terminal blocks 2 without the receptacle 12 having to be pivoted or the laser head 21 having to be displaced.

Accordingly, the different marking planes 3 are brought one after the other into the plane of the focal area 4 as a result of pivoting of the receptacle 12 and actuating of the linear guide 22 in the z-direction and/or of the linear guide 23 in the x-direction and/or of the linear guide 24 in the z-direction. All of the markings located in the marking plane 3 which is then located in the focal area 4 are applied by the laser head 21 before a subsequent plane of the marking planes is brought into the focal area 4.

After all the marking planes 3 have been processed, which are possible by pivoting movement of the receptacle 12 or by using the linear guides 23, 24 in the x- or y-direction, additional markings to be applied are carried out in the case of longer support rails 1 after linear guiding of the laser head 21 in the z-direction with the help of the linear guide 22.

As FIG. 3 shows, due to the pivotability of the receptacle 12 as desired, markings can also be applied on the under side of the terminal blocks 2. The free pivotability also makes it possible to switch the under side of the longitudinal support 13 to the other side of the terminal blocks 2. For example, if slanted downwardly inclined labeling fields are provided on the two sides of the terminal blocks 2, a rotation over the under side, that is to say a rotation wherein it is not the upper side of the terminal block 2 which passes by the laser head 21 but rather the under side of the longitudinal support 13, would lead to a rotation of less than 180°, instead of having to perform a rotation of more than 180° over the upper side.

While the preferred forms and embodiments of the invention have been illustrated and described, it will be apparent to those of ordinary skill in the art that various changes and modifications may be made without deviating from the inventive concepts set forth above.

1-13. (canceled)

14. An apparatus for marking electric devices aligned on a support rail, comprising
(a) a receptacle for receiving the support rail, said receptacle having a longitudinal axis and being mounted on a frame for pivotal movement about said longitudinal axis; and
(b) a laser assembly arranged adjacent to said receptacle for applying a marking to the electric devices, said laser assembly being guided for displacement in a direction parallel to said longitudinal axis.

15. The apparatus as defined in claim 14, wherein said receptacle includes a longitudinal support member including a receiving bed for receiving the support rail, said support member including pivot arms for connection with the frame, whereby said receiving bed is off-center with respect to a rotation axis of said receptacle.

16. The apparatus as defined in claim 15, wherein said receiving bed is arranged 20 to 30 mm off-center with respect to said rotation axis.

17. The apparatus as defined in claim 15, and further comprising a slider arranged on the longitudinal support member and movable relative to said longitudinal support member to secure support rails of different length.

18. The apparatus as defined in claim 14, and further comprising a receiving lug arranged on each of said longitudinal support member and on said slider, respectively, said receiving lugs protruding above opposite ends of said support rail.

19. The apparatus as defined in claim 15, wherein said longitudinal support member receiving bed contains at least one electromagnet for securing a support rails within said receiving bed.

20. The apparatus as defined in claim 20, and further comprising a rotary feed through connector is connected with said receptacle to deliver a current to said at least one electromagnet.

21. The apparatus as defined in claim 14, wherein said receptacle is pivotable about said longitudinal axis through a pivot angle of more than 360°.

22. The apparatus as defined in claim 15, wherein said longitudinal support member includes lateral guide plates which protrude laterally above a plane containing said receiving bed and extend in a longitudinal direction of said longitudinal support member.

23. The apparatus as defined in claim 22, wherein said lateral guide plates protrude 2 to 6 mm above the plane of said receiving bed.

24. The apparatus as defined in claim 14, and further comprising a first linear guide parallel to said receptacle and connecting said laser assembly with said receptacle for linear displacement relative to said receptacle.

25. The apparatus as defined in claim 14, and further comprising at least one additional linear guide which extends perpendicular to said first linear guide for connecting said laser assembly with said receptacle.

26. The apparatus as defined in claim 14, wherein said laser assembly includes laser head having a laser which emits in a UV wavelength range.
